(19) United States
(12) Patent Application Publication
(10) Pub. No.: US 2010/0255242 A1
(43) Pub. Date: Oct. 7, 2010

(54) PROCESS FOR ADHERING FOAM ELEMENTS AND PRODUCT THEREOF

(75) Inventor: John Dix, Burlington, NC (US)

Correspondence Address: KATTEN MUCHIN ROSENMAN LLP;(C/O PATENT ADMINISTRATOR), 2900 K STREET NW, SUITE 200, WASHINGTON, DC, 20007-5118, US

(73) Assignee: PROPRIETECT L.P., Mississauga, ON (CA)

(21) Appl. No.: 12/743,558

(22) PCT Filed: Jan. 8, 2010
(86) PCT No.: PCT/CA09/00007

§ 371 Date: May 18, 2010

Related U.S. Application Data
(60) Provisional application No. 61/019,715, filed on Jan. 8, 2008.

(51) Int. Cl. B32B 3/10; B65H 69/08; B32B 3/02; B32B 5/18

(52) U.S. Cl. 428/54; 156/157; 428/58; 428/60; 156/159; 428/71

(57) ABSTRACT

There is described a process for adhering a first elongate foam element having a first end portion to a second elongate foam element having a second end portion. The process comprises an initial step of melting a first surface portion of the first end portion to produce a first molten portion. Next the first end portion is abutted to the second end portion. Thereafter, the first molten portion is caused to solidify to create a seam bond between the first end portion and the second end portion. Thus, the present invention relates to adhering two elongate foam elements together at their end portions. The bond between the foam elements is created by melting at least a portion of the surface of one or both of the end portions of the two foam buns. This creates insitu a molten region which acts as an adhesive when the end portions of the two buns are abutted or otherwise contacted with each other.

### CROSS-REFERENCE TO RELATED APPLICATION

The present application claims the benefit under 35 U.S.C. §119(e) of provisional patent application Ser. No. 61/019,715, filed Jan. 8, 2008, the contents of which are hereby incorporated by reference.

### FIELD OF THE INVENTION

In one of its aspects, the present invention relates to a process for adhering foam elements. In other of its aspects, the present invention relates to the product formed by such a process.

### DESCRIPTION OF THE PRIOR ART

Isocyanate-based foams such as polyurethane foams are known in the art. Polyurethane foams are somewhat unique in that foaming and at least a portion of the polymerization process occur simultaneously. Thus, in the production of polyurethane foam using, for example, a conventional cold foam technique, a typical formulation comprises:
polyol (and/or other active hydrogen-containing material);
water;
catalyst;
cross-linking agent; and
polyisocyanate.

It is known to produce isocyanate-based foams such as polyurethane foams using so-called slab (also referred to as “free rise”) techniques and molding techniques—the products are conventionally referred to as slabstock foam and molded foam, respectively.

Slabstock polyurethane foams are conventionally used to produce vehicular headliners, furniture cushioning material, disposable diaper waistbands and other components of consumer products.

In a typical slab polyurethane foam production plant, the resultant foam is usually produced by dispensing a foamable composition into a trough having an open top (also known as a tunnel) and a conveyor bottom to move the composition away from the mixhead as the foam rises. Low pressure mixing is typically used and involves metering the components for foam production into a mixhead equipped with a stirrer (or other suitable agitation means) at a pressure generally less than 500 psi (usually 200-350 psi). The components are mixed in the mixhead and the foamable composition is expanded to produce polyurethane foam. As is known in the art, low pressure mixing is conventionally used to produce slabstock foam. It is known to vary the properties of the resulting foam by varying the nature and/or amount of one or more of the metered components.

Commercial slabstock polyurethane foam plants conventionally produce foam “buns” having dimensions such as 4 feet (height)×6 feet (width)×100 feet (length)—other dimensions are also possible. Each bun is then cut into a plurality shorter length (e.g., 5 feet) buns, depending on the specifications of the particular application (e.g., automotive headliner) for which the foam is produced. The shorter length bun is then sliced into sheets of appropriate thickness (e.g., ⅛ to ½ inches for vehicular headliners). For vehicular headliners, each sheet is then covered, trimmed and secured in the automobile. It is also known in the art to subject each sheet to further processing steps such as thermoforming so to confer to the planar sheet a slightly contoured appearance which more closely assumes the shape of the roof of the automobile.

Thus, slabstock polyurethane foam conventionally used in the production of automotive headliners is known as a foam (e.g., a resilient foam) having at least one uncontoured surface (i.e., the foam is a “free-rise” foam).

Additional information on vehicular headliners is set out, for example in Chapters 5 and 9 of Flexible Polyurethane Foams (Second Edition, 1997), Edited by Ron Herrington and Kathy Hock.

After production of the foam buns described above, it is conventional to use an adhesive (typically a chemical-based adhesive) to adhere the end portions of adjacent buns and thereafter to loop the train of adhered buns in a bent fashion in a device known as a looper. The looper serves the purpose of cutting thin sheets of foam that are stored on rolls or in stacks for further processing. Conventionally, the chemical-based adhesive compound is sprayed on the end portions of each bun and a waiting period is necessary to allow the end portions to adhere to each other.

A problem with the approach is that, after the foam bun is cut into relatively sheets, a relatively hard seam line is produced in the relatively thin sheet corresponding to the seam between the end portions of the buns that are adhered together. When a thin piece of foam containing such a hard seam line is subsequently flame laminated (or otherwise adhered) to trim cover material for a vehicular headliner, furniture or other application, the hard seam line can be felt through the trim cover material. This results in the need to scrap those pieces with the hard seam line. Practically, this translates into the single largest source of scrap in flame laminating equipment used to convert the thin sheets to a final product for use in the intended application.

In addition, the current approach of using a chemical-based adhesive requires a waiting time for the adhesive to secure the two end portions of the buns together. This can result in significant loss of efficiency of the machinery used to process the foam buns.

Still further, most commercially used utilisable adhesives are solvent base and the use thereof results in release of the solvents to the environment.

Accordingly, it would be desirable to have a solution to these problems. More specifically, it would be desirable to have a process for adhering foam elements such as slabstock foam buns which were substantially free of the hard seam line described above. It would be additionally advantageous if this could be done while also avoiding the need to use chemical-based adhesive systems (and similar adhesive systems) owing to the reduced throughput efficiency and environmental concerns associated with the use of such adhesive systems.

### DISCLOSURE OF THE INVENTION

It is an object of the present invention to obviate or mitigate at least one of the above-mentioned disadvantages of the prior art.

It is another object of the present invention to provide a novel process for adhering foam elements.

Accordingly, in one of its aspects, the present invention provides a process for adhering a first elongate foam element having a first end portion to a second elongate foam element having a second end portion comprising the steps of:
(a) melting a first surface portion of the first end portion to produce a first molten portion;
(b) abutting the first end portion to the second end portion;
(c) causing the first molten portion to solidify to create a seam bond between the first end portion and the second end portion.

In another of its aspects, the present invention provides a foam product produced by such a process.

Thus, in its broader sense, an aspect of the present invention relates to adhering two elongate foam elements together at their end portions. The bond between the foam elements is created by melting at least a portion of the surface of one or both of the end portions of the two foam buns. This creates in situ a molten region which acts as an adhesive when the end portions of the two buns are abutted or otherwise contacted with each other.

The advantage of this approach is that it avoids the use of chemical-based adhesive systems and the problems associated with those systems discussed above. More importantly, the use of this technique results in the provision of a relatively soft seam bond compared to the seam bond that is created using the chemical-based adhesive systems described above. Accordingly, when the product of the process containing two or more adhered foam buns is sliced into relatively thin foam sheets, those foam sheets that contain the seam bond can still be used in a final application with the seam bond being of acceptable quality to obviate or mitigate the scrap problems described above.

A further advantage of this approach is that a waiting time for the molten region at the end portion(s) of the foam buns to form the bond is significantly less then that necessary when using chemical-based adhesives. This results in increased throughput and efficiency at the manufacturing level.

Aspects of the invention also relate to a product formed by this process.

In addition, aspects of the invention relate to further processing of the resultant in foam product to produce relatively thin sheets of foam can be used as is or further processed (e.g., in the case of vehicular headliners) to produce a final product. When this final product contains the seam bond produced according to the present process, it is still of acceptable quality to be used in consumer product without the need to scrap the product as is currently the case when using chemical-based adhesive and similar systems.

### DETAILED DESCRIPTION OF THE PREFERRED EMBODIMENTS

Generally, the present process is one for adhering a first elongate foam element having a first end portion to a second elongate foam element having a second end portion. The process comprises melting a first surface portion of the first end portion to produce a first a molten portion. The first end portion and the second end portion are then abutted or otherwise contacted to each other (e.g., preferably with compression) for a period sufficient for the first molten portion to substantially solidify to create a seam bond between the first end portion and the second end portion.

Preferably, the first molten portion is substantially coterminous with the first end portion.

In the melting step (i.e., Step (a) above), it is preferred to pass a heat source near the first surface portion. Preferably, the heat source is a flame although other heat sources (e.g., infrared heat sources) may be used. The heating step is preferably conducted to achieve melting of the surface (preferably the entire surface) of the end portion of the first foam element to achieve a substantially continuous molten region at that surface. This molten region may be relatively thin (e.g., less than 5 mm thick, preferably from about 1 mm to about 3 mm thick).

In a particularly preferred embodiment, the process comprises the further step prior to Step (b) (the abutting step) of melting a second surface portion of the second end portion to produce a second molten portion. This additional heating step is preferably conducted to achieve melting of the surface (preferably the entire surface) of the end portion of the second foam element to achieve a substantially continuous molten region at that surface. Again, this molten region may be relatively thin (e.g., less than 5 mm thick, preferably from about 1 mm to about 3 mm thick). In this particularly preferred embodiment, Step (c) above further comprises causing the second molten portion to solidify to create a bond between the first end portion and the second end portion. In this preferred embodiment, it is preferred that Step (b) comprises abutting the first molten portion to the second molten portion. Also it is preferred in this embodiment that the second molten portion is substantially coterminous with the second end portion.

In a highly preferred embodiment, the melting step is applied to the surface of both end portions to produce a substantially continuous molten region (preferably relatively thin as described above) on each of the end portions. This results in the production of a substantially continuous seam bond.

When the process comprises melting the surface of each end portion, to is preferred to pass a heat source near the second surface portion of the second foam element. As with the first foam element, it is preferred that the heat source is a flame although other heat sources are possible.

Preferably, the first foam element and the second foam element have the same dimensions, although it is possible to adapt the present process to the situation where the first foam element and the second foam element have different dimensions.

The first end portion and the second end portion have substantially the same cross-sectional dimensions, although it is possible to adapt the present process to the situation where the first end portion and the second end portion have different cross-sectional dimensions.

The process is advantageously used to adhere foam elements in the form of slabstock foam buns as described above.

In one embodiment, one or both of the first foam element have a length of up to about 150 ft, a height of up to about 8 ft. and a width of up to about 8 ft, although other dimensions are possible. Preferably, one or both the first foam element and the second foam element have a length in the range of from about 5 ft. about 120 ft, a height in the range of from about 3 ft. to about 6 ft. and a width in the range of from about 3 ft. to about 6 ft. More preferably, one or both of the first foam element and the second foam element has a length in the range of from about 50 ft. about 120 ft, a height in the range of from about 3 ft. to about 6 ft. and a width in the range of from about 3 ft. to about 6 ft.

In one embodiment of the present process, the first end portion comprises a first surface that is substantially normal to a longitudinal axis of the first foam element and the second end portion comprises a second surface that is substantially normal to a longitudinal axis of the first foam element—i.e., this covers the situation where the end portion of the elongate foam elements effectively has a perpendicular cross-sectional surface to the length of the elongate foam elements.

In another embodiment of the present process, the first end portion comprises a first surface that is obliquely angled with respect to a longitudinal axis of the first foam element to define a first oblique angle (e.g., 30°-75°) and the second end portion comprises a second surface that is obliquely angled with respect to a longitudinal axis of the first foam element to define a second oblique angle (e.g., 30°-75°). More preferably, the first oblique angle and the second oblique angle are substantially supplementary (the two angles add up to 180°)—i.e., this covers the situation where the end portion of the elongate foam elements effectively has an angled cross-sectional surface to the length of the elongate foam elements.

Preferably, one or both of the first foam element and the second foam element comprise an isocyanate-based foam. More preferably, one or both of the first foam element and the second foam element comprise polyurethane foam. Most preferably, one or both of the first foam element and the second foam element comprise polyurethane slabstock foam.

Of course, the present process may be adapted to adhere more than two foam elements.

As discussed above, aspects of the invention also relate to
an adhered foam product produced by the above process;
a process for producing a foam part comprising the step of cutting the adhered foam product (preferably in a direction of the longitudinal axis of the adhered foam product) to produce a relatively thin foam part containing the seam bond seam;
a relatively thin foam part produced this process, including the further optional steps of: (i) forming the relatively thin foam part to have a predetermined shape; and (ii) securing a trim cover to at least one major surface of the foam part to produce a covered foam part; and
a covered foam part produced according to this process.

While this invention has been described with reference to illustrative embodiments and examples, the description is not intended to be construed in a limiting sense. Thus, various modifications of the illustrative embodiments, as well as other embodiments of the invention, will be apparent to persons skilled in the art upon reference to this description. It is therefore contemplated that the appended claims will cover any such modifications or embodiments.

All publications, patents and patent applications referred to herein are incorporated by reference in their entirety to the same extent as if each individual publication, patent or patent application was specifically and individually indicated to be incorporated by reference in its entirety.

1. A process for adhering a first elongate foam element having a first end portion to a second elongate foam element having a second end portion comprising the steps of:
(a) melting a first surface portion of the first end portion to produce a first molten portion;
(b) abutting the first end portion to the second end portion;
(c) causing the first molten portion to solidify to create a seam bond between the first end portion and the second end portion.

2. The process defined in claim 1, wherein the first molten portion is substantially coterminous with the first end portion.

3. The process defined in claim 1, wherein Step (a) comprising passing a heat source near the first surface portion.

4. The process defined in claim 3, the heat source comprises a flame.

5. The process defined in claim 1, comprising the further step prior to Step (b) of melting a second surface portion of the second end portion to produce a second molten portion and Step (c) further comprises causing the second molten portion to solidify to create a bond between the first end portion and the second end portion.

6. The process defined in claim 5, wherein Step (b) comprises abutting the first molten portion to the second molten portion.

7. The process defined in claim 5, wherein the second molten portion is substantially coterminous with the second end portion.

8. The process defined in claim 5, wherein the further step comprises passing a heat source near the second surface portion.

9. The process defined in claim 8, the heat source comprises a flame.

10. The process defined in claim 1, wherein the first foam element and the second foam element have the same dimensions.

11. The process defined in claim 1, wherein the first foam element and the second foam element have different dimensions.

12. The process defined in claim 1, wherein the first end portion and the second end portion have substantially the same cross-sectional dimensions.

13. The process defined in claim 1, wherein the first end portion and the second end portion have different cross-sectional dimensions.

14. The process defined in claim 1, wherein the first foam element has a length of up to about 150 ft, a height of up to about 8 ft. and a width of up to about 8 ft.

15. The process defined in claim 1, wherein the second foam element has a length of up to about 150 ft, a height of up to about 8 ft. and a width of up to about 8 ft.

16. The process defined in claim 1, wherein the first foam element has a length in the range of from about 5 ft. about 120 ft, a height in the range of from about 3 ft. to about 6 ft. and a width in the range of from about 3 ft. to about 6 ft.

17. The process defined in claim 1, wherein the second foam element has a length in the range of from about from about 50 ft to about 120 ft, a height in the range of from about 3 ft. to about 6 ft. and a width in the range of from about 3 ft. to about 6 ft.

18. The process defined in claim 1, wherein the first foam element has a length in the range of from about 50 ft. about 120 ft, a height in the range of from about 3 ft. to about 6 ft. and a width in the range of from about 3 ft. to about 6 ft.

19. The process defined in claim 1, wherein the second foam element has a length in the range of from about from about 5 ft to about 120 ft, a height in the range of from about 3 ft. to about 6 ft. and a width in the range of from about 3 ft. to about 6 ft.

20. The process defined in claim 1, wherein the first end portion comprises a first surface that is substantially normal to a longitudinal axis of the first foam element and the second end portion comprises a second surface that is substantially normal to a longitudinal axis of the first foam element.

21. The process defined in claim 1, wherein the first end portion comprises a first surface that is obliquely angled with respect to a longitudinal axis of the first foam element to define a first oblique angle and the second end portion comprises a second surface that is obliquely angled with respect to a longitudinal axis of the first foam element to define a second oblique angle.

22. The process defined in claim 21, wherein the first oblique angle and the second oblique angle are substantially supplementary (add up to 180°).

23. The process defined in claim 1, wherein one or both of the first foam element and the second foam element comprise an isocyanate-based foam.

24. The process defined in claim 1, wherein one or both of the first foam element and the second foam element comprise polyurethane foam.

25. The process defined in claim 1, wherein one or both of the first foam element and the second foam element comprise polyurethane slabstock foam.

26. The process defined in claim 1, comprising adhering more than two foam elements.

27. A foam product produced by the process defined in claim 1.

28. A process for producing a foam part, comprising the step of cutting the foam product defined in claim 27 to produce a relatively thin foam part containing the seam bond seam.

29. A foam part produced according to the process defined in claim 28.

30. The process defined in claim 28 comprising the further steps of:
(a) form the foam part to have a predetermined shape; and
(b) securing a trim cover to at least one major surface of the foam part to produce a covered foam part.

31. A covered foam part produced according to the process defined in claim 30.
